(19) United States
(12) Patent Application Publication
(10) Pub. No.: US 2021/0362140 A1
(43) Pub. Date: Nov. 25, 2021

(54) A CATALYST AND METHOD OF USE THEREOF

(71) Applicant: SHELL OIL COMPANY, Houston, TX (US)

(72) Inventors: Wenzhong ZHANG, Houston, TX (US); Geert Marten BANKKER, Amsterdam (NL); Steven Russell LEE, Houston, TX (US)

(21) Appl. No.: 16/630,105

(22) PCT Filed: Jul. 9, 2018
(86) PCT No.: PCT/US2018/041279

§ 371 Date: Jan. 10, 2020

Related U.S. Application Data
(60) Provisional application No. 62/530,877, filed on Jul. 11, 2017.

(51) Int. Cl. B01J 29/80; B01J 29/76; B01J 37/30; B01J 35/10; B01J 35/02; B01D 53/86; B01D 53/94

(52) U.S. Cl. CPC B01J 29/80; B01J 29/763; B01J 29/7615; B01J 37/30; B01J 35/1057; B01D 2255/9202; B01D 53/8628; B01D 53/9418; B01D 2255/502; B01D 2255/20738; B01J 35/023

(57) ABSTRACT

A catalyst for the conversion of NO_{X} comprising iron chabazite and iron beta zeolite and a method of reducing the NOX concentration in a process gas stream comprising contacting the process gas stream with the catalyst. The catalyst is especially useful for high temperature deNO_{X} conversion.

The present application claims the benefit of U.S. Provisional Application Ser. No. 62/530,877, filed 11 Jul. 2017.

### FIELD OF THE INVENTION

The invention relates to a catalyst and a method of reducing the NOX concentration in a process gas stream using that catalyst.

### BACKGROUND OF THE INVENTION

Nitric oxides are known polluting gases and efforts have been made to limit the amount of these compounds entering the atmosphere. These are found in exhaust gases and process gas streams in a number of industrial processes. In addition, these are found in the exhaust gases of mobile vehicles; cars, trucks, buses, etc. Selective catalytic reduction is a known method for removing these compounds from process gas streams by converting nitric oxides to nitrogen and water.

US 20110286914 discloses an organic-free, metal-containing zeolite Beta with a silica-to-alumina ratio ranging from 5 to 20, and a metal content of at least 0.5 wt %. The published patent application also discloses a method of selective catalytic reduction of nitrogen oxides in exhaust gases using the zeolite Beta.

US 20130142727 discloses a microporous crystalline material having a pore opening ranging from 3 to 5 Angstroms, where the material comprises a first metal chosen from alkali earth group, rare earth group, alkali group, or mixtures thereof, and a second metal chosen from iron, copper or mixtures thereof; and has a molar silica to alumina ratio from 3 to 10. The published patent application also discloses a method of selective catalytic reduction of nitrogen oxides in exhaust gas.

It is advantageous to develop improved catalysts that are more effective and more stable in this reaction so that the units can be operated over a longer duration without maintenance or catalyst replacement.

### SUMMARY OF THE INVENTION

The invention provides a method of reducing the NO_{X} concentration in a process gas stream comprising contacting the process gas stream with a catalyst comprising iron chabazite and iron beta zeolite under NO_{X} conversion conditions. Preferred NO_{X} conversion conditions include a high temperature.

The invention provides a catalyst for the conversion of NO_{X} comprising iron chabazite and iron beta zeolite.

### BRIEF DESCRIPTION OF THE FIGURES

FIG. 1 depicts the NO_{X} conversion of a catalyst comprising iron chabazite and iron beta zeolite under varying conditions.

### DETAILED DESCRIPTION OF THE INVENTION

The invention provides an improved catalyst for the conversion of NO_{R}. The catalyst comprises iron chabazite and iron beta zeolite.

The beta zeolite is preferably made without an organic structure directing agent. The resulting beta zeolite does not contain any residual organic materials in the pores of the material, and thus the treatments usually required to remove the organic components are not needed. In prior art catalysts, organic structure directing agents, such as tetraethylammonium hydroxide, dibenzylmethylammonium, and dibenzyl-dimethyl ammonium hydroxide, were used in the precursor materials. The cost of these compounds and the fact that they usually remain in the pores after manufacture is a problem in the synthesis of these iron beta zeolite materials.

The beta zeolite preferably has a silica-to-alumina ratio of from 5 to 20. The silica-to-alumina ratio is preferably not more than 12, and more preferably in a range of from 5 to 11. The beta zeolite preferably has an average crystal size of greater than 0.1 microns, more preferably of from 0.2 to 5 microns.

The iron beta zeolite made using the above described beta zeolite preferably comprises at least 0.5 wt % iron, more preferably from 1 to 10 wt % iron. The catalyst may also contain alumina.

The iron is preferably added to the catalyst components (chabazite and beta zeolite) by one or more methods, including liquid phase or solid ion exchange, impregnation or incorporation by direct synthesis. In a preferred embodiment, the iron is preferably added by ion exchange.

The iron used in the ion exchange method is typically an iron salt and it may be ferric nitrate, ferric chloride, ferrous chloride, ferrous sulfate or mixtures thereof.

One method for making the beta zeolite starts with making an aqueous solution comprising NaOH and a source of alumina. The alumina source may be sodium aluminate, aluminum hydroxide, alumina, aluminum nitrate, aluminum alcoholates, or aluminum sulfate. Then a source of silica is added to the solution. The silica may comprise a silica gel, silica sol, silica hydrosols, fumed silica, reactive amorphous solid silicas, silicic acid, water glass, sodium silicate, sodium metasilicate, colloidal silicate, pyrogenic silica, precipitated silicate, silica alumina and other similar materials. Then a source of beta zeolite is added and the mixture is mixed to form a gel. The source of beta zeolite may be a commercially available beta zeolite. The gel is heated to form a product and this step is carried out until the desired crystal size and purity are achieved. The heating may comprise heating the gel at a temperature ranging from 100 to 200° C. for up to 200 hours. Once the crystallized material is formed, it may be treated by isolation, washing and drying. The isolation may be carried out by any method known to one of skill in the art, including filtration, centrifugation or decantation. The washing may be carried out with any known agent including water or alcohols. Additionally, sodium may be removed from the zeolite, by, for example, ion exchange.

In another embodiment, the beta zeolite may be made by preparing a mixture of seed crystals, a source of SiO₂ and a source of Al₂O₃ and crystallizing the mixture. The seed crystals may be beta zeolite crystals.

The chabazite is preferably also made without an organic structure directing agent. This provides similar benefits as described above with regards to the iron beta zeolite. The chabazite may be made by mixing sources of sodium, potassium, alumina, silica, and water to form a gel and then heating the gel at a temperature in the range of from 80 to 200° C. The crystalline product formed can then be ammonium-exchanged.

The chabazite prepared without an organic structure directing agent preferably has a pore opening of from 3 to 5 Angstroms. The chabazite preferably has a silica-to-alumina ratio of from 3 to 10. The iron chabazite preferably has an average crystal size of from 0.3 to 10 microns, preferably from 0.3 to 5.0 microns.

The iron chabazite made using the above described chabazite preferably comprises from 0.5 to 5.0 wt % iron. The iron may be added by liquid phase or solid ion exchange. Alternatively, the iron may be added by impregnation or may be added during the zeolite synthesis steps.

The catalyst comprising iron chabazite and iron beta zeolite may be in the form of channeled or honeycomb, metal plate type or corrugated plate type catalyst. Alternatively, the catalyst may be present as a packed bed, which may comprise balls, pebbles, pellets, tablets or extrudates. The catalyst may be present in the form of microspheres.

The catalyst may be formed by creating a slurry of a fine powder of the zeolite materials, which is then admixed with a suitable binder. The binder may comprise alumina, bentonite, silica or silica-alumina. The slurry may then be deposited on a suitable substrate in the form of a honeycomb or other shape with a plurality of channels.

The catalyst may comprise a blend of iron chabazite and iron beta zeolite, a plurality of layers where each layer comprises an individual iron chabazite or iron beta zeolite component or a plurality of zones where each zone comprises an individual iron chabazite or iron beta zeolite component. A blend of the catalysts may comprise a volume of both the iron chabazite and the iron beta zeolite having approximately the same proportions relative to one another throughout the volume of the blend. In another embodiment, the blend of catalysts may be disposed in a plurality of layers or zones.

The catalyst can be used in a method for reducing the NOx concentration in a process gas stream. In the process, the process gas stream is contacted with the catalyst under conversion conditions. The conversion conditions may include a temperature in the range of from 250 to 650° C.

Ammonia, urea, or an ammonia generating compound may be added to the process gas before or at the same time as the process gas is contacted with the catalyst. The ammonia generating compound may be ammonium carbamate, ammonium formate, ammonium carbonate or metal-amine complexes.

In addition to ammonia, the contacting may be carried out in the presence of water. The water may be present in an amount of at least 0.5 vol. %, preferably at least 2 vol %, calculated as a percentage of the combined process gas, ammonia, and water stream.

### EXAMPLES

### Example 1

This example demonstrates the impact of hydrothermal aging on a catalyst comprising both iron chabazite and iron beta zeolite. The NOx conversion of the fresh catalyst was measured at a number of temperatures from 300 to 750° C. The catalyst was subsequently hydrothermally aged by contacting with an 11% H₂O stream for 16 hours at 760° C. The NOx conversion of the aged catalyst was measured at a number of temperatures from 300 to 750° C. The catalyst was further hydrothermally aged by contacting with an 11% H₂O stream for an additional 10 hours (for a total of 26 hours). The NOx conversion of the catalyst was measured at a number of temperatures from 300 to 750° C.

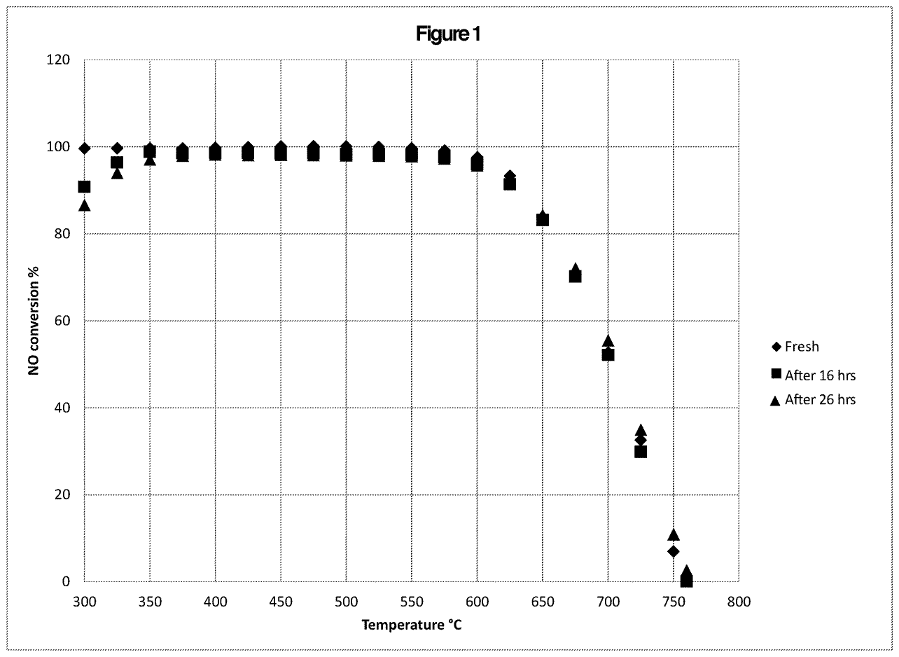

The NOx conversion of the fresh, aged and further aged catalyst are shown in FIG. 1. As can be seen from the FIGURE, the impact of hydrothermal aging on the catalyst performance is negligible. The catalyst of the invention demonstrates improved hydrothermal stability compared to other catalysts.

1. A method of reducing NO_{X} concentration in a process gas stream comprising contacting the process gas stream with a catalyst comprising iron chabazite and iron beta zeolite under NO_{X} conversion conditions.

2. The method of claim 1, wherein the conversion conditions comprise a temperature in the range of from 250 to 700° C.

3. The method of claim 1, wherein the conversion conditions comprise a temperature in the range of from 325 to 675° C.

4. The method of claim 1, wherein the conversion conditions comprise a temperature in the range of from 480 to 650° C.

5. The method of claim 1, comprising adding ammonia, urea or an ammonia generating compound to the process gas before or at the same time as the process gas is contacted with the catalyst.

6. The method of claim 5, wherein the ammonia generating compound is selected from the group consisting of ammonium carbamate, ammonium formate, ammonium carbonate and metal-amine complexes.

7. The method of claim 1, wherein the contacting is carried out in the presence of at least 0.5 vol % water.

8. The method of claim 1, wherein the contacting is carried out in the presence of at least 2 vol % water.

9. A catalyst for conversion of NO_{X} comprising iron chabazite and iron beta zeolite.

10. The catalyst of claim 9, wherein the iron chabazite is made without an organic structure directing agent.

11. The catalyst of claim 9, wherein the iron chabazite has a pore opening of from 3 to 5 Angstroms.

12. The catalyst of claim 9, wherein the iron chabazite has a silica-to-alumina ratio of from 3 to 10.

13. The catalyst of claim 9, wherein the iron chabazite has an average crystal size of from 0.3 to less than 10 microns.

14. The catalyst of claim 9, wherein the iron chabazite has an average crystal size of from 0.3 to 5.0 microns.

15. The catalyst of claim 9, wherein the iron chabazite comprises from 0.5 to 5.0 wt % of iron.

16. The catalyst of claim 9, wherein the iron beta is made without an organic structure directing agent.

17. The catalyst of claim 9, wherein the iron beta has a silica-to-alumina ratio of from 5 to 20.

18. The catalyst of claim 9, wherein the iron beta has a silica-to-alumina ratio of from 5 to 11.

19. The catalyst of claim 9, wherein the iron beta comprises at least 0.5 wt % of iron.

20. The catalyst of claim 9, wherein the iron beta comprises from 1 to 10 wt % iron.

21. The catalyst of claim 9, wherein the iron beta has an average crystal size of greater than 0.1 microns.

22. The catalyst of claim 9, wherein the iron beta has an average crystal size of from 0.2 to 5 microns.

23. The catalyst of claim 9, wherein the iron was added to the beta zeolite and the chabazite zeolite by ion exchange.

24. The catalyst of claim 23, wherein the iron used in the ion exchange method was an iron salt selected from the group consisting of ferric nitrate, ferric chloride, ferrous chloride, ferrous sulfate and mixtures thereof.

25. The catalyst of claim 9, comprising alumina.
